(19) United States
(12) Patent Application Publication
(10) Pub. No.: US 2026/0138489 A1
(43) Pub. Date: May 21, 2026

(54) POWER SUPPLY APPARATUS AND POWER SUPPLY MANAGEMENT METHOD THEREOF

(71) Applicant: Lite-On Technology Corporation, Taipei (TW)

(72) Inventor: Ching-Chi Chen, Taipei (TW)

(73) Assignee: Lite-On Technology Corporation, Taipei (TW)

(21) Appl. No.: 19/360,997

(22) Filed: Oct. 17, 2025

Related U.S. Application Data
(60) Provisional application No. 63/723,131, filed on Nov. 21, 2024.

(30) Foreign Application Priority Data
Sep. 12, 2025 (CN) 202511306861.7

(51) Int. Cl. B60L 53/66; G06Q 20/14; G06Q 20/40

(52) U.S. Cl. CPC B60L 53/665; G06Q 20/145; G06Q 20/401; G06Q 20/4097

(57) ABSTRACT

A power supply apparatus and a power supply management method thereof are provided. The power supply apparatus includes an information capturing device and a processor. The processor is coupled to the information capturing device. In response to the information capturing device detecting a payment instrument, the processor identifies a payment type of the payment instrument. The processor performs a charging authorization verification of the payment instrument based on the payment type identified. In response to the charging authorization verification being determined successful, the processor initiates a power transfer operation and executes a charging transaction with the payment instrument.

### CROSS-REFERENCE TO RELATED APPLICATION

This application claims the priority benefits of U.S. provisional application serial no. 63/723,131, filed on November 21, 2024, and China application serial no. 202511306861.7, filed on September 12, 2025. The entirety of each of the above-mentioned patent applications is hereby incorporated by reference herein and made a part of this specification.

### BACKGROUND

### Technical Field

The disclosure relates to payment technology for power supply apparatus, and particularly relates to a power supply apparatus and a power supply management method thereof.

### Related Art

To reduce carbon emissions and address issues related to global warming, countries around the world have been actively promoting the development of electric vehicle (EV) technologies and have set long-term goals to ban the sale of fuel-powered vehicles. Governments and industries are implementing policies and subsidy programs to accelerate the adoption and market growth of EVs. However, as the number of EVs rapidly increases, the design and management of charging infrastructure face numerous challenges. Currently, the payment mechanisms for EV charging equipment still present inconveniences for users. For example, different users may possess various types of payment tools, such as credit cards, membership cards, or mobile electronic devices, which complicates the payment process. Furthermore, most existing EV charging equipment requires users to select a payment method via touch panels or buttons. These systems often need separate sensing areas for different types of cards, which can confuse users or require additional guidance, ultimately affecting payment efficiency.

### SUMMARY

In light of above, the disclosure provides a power supply apparatus and a power supply management method, which can automatically identify the payment type of the payment instrument possessed by a user. The disclosure enables the power supply apparatus to read and verify multiple payment instruments via a unified sensing area.

An embodiment of the disclosure provides a power supply apparatus, which includes an information capturing device and a processor. The processor is coupled to the information capturing device. In response to the information capturing device detecting a payment instrument, the processor identifies a payment type of the payment instrument. The processor performs a charging authorization verification to the payment instrument based on the identified payment type. In response to the charging authorization verification being determined successful, the processor initiates a power transfer operation and executes a charging transaction with the payment instrument.

From another perspective, an embodiment of the disclosure provides a power supply management method, applicable to a power supply apparatus including an information capturing device. The method includes the following steps. In response to the information capturing device detecting a payment instrument, a processor identifies a payment type of the payment instrument. The processor performs a charging authorization verification of the payment instrument based on the identified payment type. In response to the charging authorization verification being determined successful, the processor initiates a power transfer operation and executes a charging transaction with the payment instrument.

From another perspective, an embodiment of the disclosure provides a power supply apparatus, which includes a main body, a charging port, an information capturing device, and a processor. The charging port is connected to the main body for outputting electrical power. The information capturing device is disposed on the main body for collecting information from a payment instrument. The processor is disposed the main body and coupled to the charging port and the information capturing device. The processor identifies information from the payment instrument and controls the charging port to output power based on the identified information.

Based on the above, in the embodiments of the disclosure, when the information capturing device of the power supply apparatus senses a payment instrument, the power supply apparatus can automatically identify the payment type of the payment instrument. Thereafter, the power supply apparatus may proceed with charging authorization verification based on the identified payment type of the payment instrument, so as to execute a charging transaction based on the payment instrument upon successful verification. Based on the above, users can make payment without selecting payment methods or changing card sensing positions, making the charging payment experience more intuitive and efficient.

### BRIEF DESCRIPTION OF THE DRAWINGS

FIG. 1 is a schematic diagram of a charging payment system according to an embodiment of the disclosure.

FIG. 2 is a schematic diagram of an information capturing device according to an embodiment of the disclosure.

FIG. 3 is a flowchart of a power supply management method according to an embodiment of the disclosure.

FIG. 4 is a schematic diagram of a payment type being a membership payment type according to an embodiment of the disclosure.

FIG. 5 is a schematic diagram of a payment type being a direct payment type according to an embodiment of the disclosure.

FIG. 6 is a schematic diagram of a payment type being a hybrid payment type according to an embodiment of the disclosure.

FIG. 7 is a flowchart of a power supply management method according to an embodiment of the disclosure.

FIG. 8 is a flowchart of a power supply management method according to an embodiment of the disclosure.

### DESCRIPTION OF THE EMBODIMENTS

Embodiments of the disclosure will be described in detail with reference to the accompanying drawings. In the following description, same reference numerals in different drawings represent the same or similar components. These embodiments are merely a part of the invention and do not disclose all possible implementations. More specifically, these embodiments are merely examples of the methods and devices of the appended claims. In particular, although the disclosure may describe the steps of the embodiments and use corresponding reference numerals in sequential manner, the order of the steps and reference numerals is intended solely for ease of understanding and should not be construed as limiting the necessity or specific sequence of any steps.

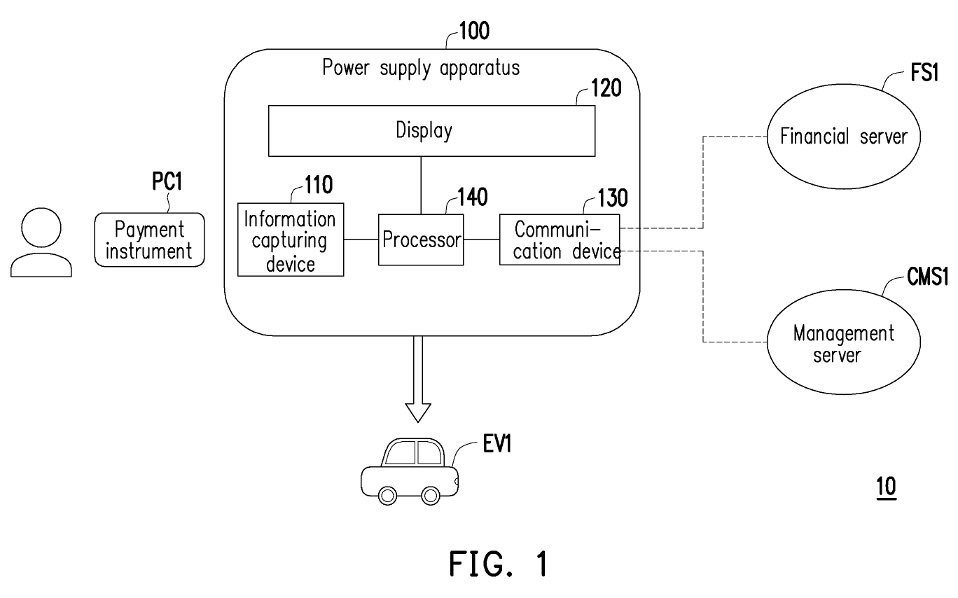

FIG. 1 is a schematic diagram of a charging payment system according to an embodiment of the disclosure. Referring to FIG. 1, the charging payment system 10 may include a power supply apparatus 100, a payment instrument PC1, a financial server FS1, and a management server CMS1.

The payment instrument PC1 is a payment tool that is capable of paying charging fees. A user may conduct authorization verifications and transactions of the payment instrument PC1at the power supply apparatus 100. The payment instrument PC1 may be, for example, a bank card, a membership card, a mobile payment device, or a stored-value card. A bank card may be, for example, a credit card or debit card. From another perspective, the payment instrument PC1 may be, for example, a magnetic stripe card, chip card, Radio Frequency Identification (RFID) card, Near-field communication (NFC) card, RFID identification tag, or mobile electronic device supporting NFC function.

The power supply apparatus 100 may be, for example, a charging apparatus capable of providing charging service to an Electric Vehicle (EV) EV1, and may include a charging port configured to output power. In some embodiments, the power supply apparatus 100 may communicate with a Charging Station Management System (CSMS) through Open Charge Point Protocol (OCPP).

In some embodiments, the power supply apparatus 100 includes an information capturing device 110, a display 120, a communication device 130, and a processor 140, disposed in the main body of the power supply apparatus 100. The processor 140 is coupled to the information capturing device 110, the display 120, and the communication device 130.

The display 120 is configured to display the operating status and charging transaction information of the power supply apparatus 100, such as charging status, charging time, rates and total fees, payment confirmation message, waiting time, charging current. The display may be, for example, an LCD, LED, or other types of screens.

The communication device 130 provides network connection function, allowing the power supply apparatus 100 to connect to public networks or private networks based on wired or wireless communication standards and communicate with other electronic devices. The communication device 130 may include, for example, transceivers, antennas, or wired signal transmission ports. For example, the communication device 130 may include electronic components supporting Long Term Evolution (LTE) standards, 5G standards, Wi-Fi standards, Ethernet standards, but the disclosure is not limited thereto. In embodiments of the disclosure, the power supply apparatus 100 may communicate with external servers such as the management server CMS1 and the financial server FS1 through the communication device 130.

The processor 140 may be a general-purpose or special-purpose programmable processor, including but not limited to a Microcontroller (MCU), Microprocessor Unit (MPU), Digital Signal Processor (DSP), Field Programmable Gate Array (FPGA), System-on-Chip (SoC), or other similar components or combinations of the above components. The processor 140 is responsible for integrating and controlling the overall operations of the power supply apparatus 100, and is coupled with other components through internal data bus or communication interface.

The information capturing device 110 of the power supply apparatus 100 includes a sensing area, which is capable of supporting different types of payment instruments PC1, so that the power supply apparatus 100 may acquire information of different types of payment instruments PC1, for examples, first information of a first payment instrument or second information of a second payment instrument, through an unified sensing area of the information capturing device 110, and send it to the processor 140. The sensing area of the information capturing device 110 and the display 120 may be disposed on the same surface of the main body. That is, regardless of whether the payment instrument PC1 held by the user is a contactless credit card, membership card, or mobile payment device, the user can perform sensing of the payment instrument PC1 through a same area. There is no need to change the sensing area or manually select the payment method based on the type of the payment instrument PC1 used.

The management server CMS1 is capable of managing charging transaction processes, including, for example, receiving charging authorization requests, monitoring charging status, calculating charging fees. In some embodiments, the management server CMS1 may be an OCPP server in a Charging Station Management System (CSMS). The financial server FS1 may be a payment processing system of a financial institution, which may process authorization, settlement, and transaction security verification for credit cards, debit cards, or electronic payments.

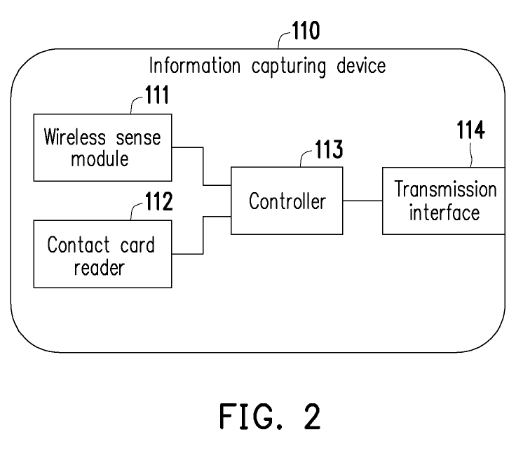

FIG. 2 is a schematic diagram of an information capturing device according to an embodiment of the disclosure. Referring to FIG. 2, the information capturing device 110 may include a wireless sense module 111, a contact card reader 112, a controller 113, and a transmission interface 114. The controller 113 is coupled to the wireless sense module 111, the contact card reader 112, and the transmission interface 114, and is responsible for integrating and controlling the overall operations of the information capturing device 110.

The wireless sense module 111 is capable of contactlessly sensing the payment instrument PC1. When the payment instrument PC1 supporting contactless payment technology approaches the wireless sense module 111, the wireless sense module 111 may detect and read data provided by the payment instrument PC1. More specifically, the wireless sense module 111 may include an antenna and a wireless transceiver. The wireless sense module 111 may be, for example, an NFC module. Additionally, the contact card reader 112 may be configured to read the payment instrument PC1 in a contact manner. The contact card reader 112 may, for example, include a card slot. When the payment instrument PC1 is, for example, a chip card or magnetic stripe card, the user may choose to insert or contact the payment instrument PC1 with the contact card reader 112, and the contact card reader 112 may read data provided by the payment instrument PC1. The information capturing device 110 may transmit the acquired data to the processor 140 of the power supply apparatus 100 through the transmission interface 114 (such as a UART interface).

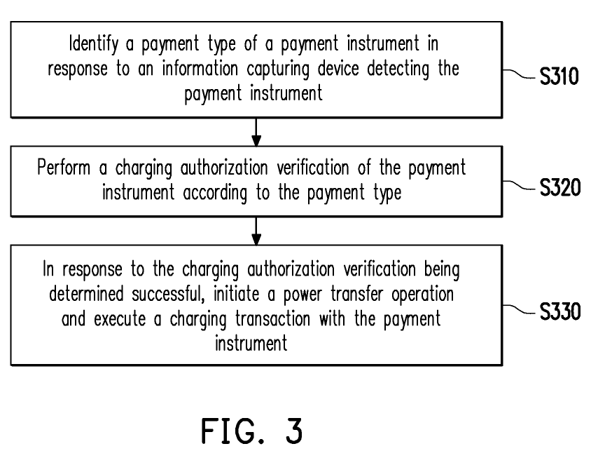

FIG. 3 is a flowchart of a power supply management method according to an embodiment of the disclosure. Referring to FIG. 3, the method flow of this embodiment is applicable to the charging payment system 10 in the above-mentioned embodiments, and the detailed steps of this embodiment will be described below together with various components in the charging payment system 10.

In Step S310, in response to the information capturing device 110 detecting a payment instrument PC1, the processor 140 identifies a payment type of the payment instrument PC1. In some embodiments, the processor 140 acquires data provided by the payment instrument PC1 through the information capturing device 110, and identifies if the payment type of the payment instrument PC1 is a membership payment type, a direct payment type, or a hybrid payment type. The automatic identification of the payment type enables reduce of user operation steps, making the payment process more intuitive.

In some embodiments, the membership payment type applies to users with a membership status. The payment instrument PC1 may be, for example, an RFID membership card, NFC member account, or stored-value card. When the payment instrument PC1 is identified as a membership payment type, charging fees may be deducted from the member account of the user without additional payment authorization of credit card or debit card. Direct payment type applies to bank cards such as credit cards and debit cards, or mobile payment devices, which real-time authorization and transaction settlement with the financial server FS1 are required. When the payment instrument PC1 is identified as a direct payment type, charging fees may be paid through real-time transactions, regardless of the member account or pre-stored balance. Hybrid payment type applies to users having a membership status paying with bank cards. When a user binds membership card and bank card to a single mobile electronic device, the information capturing device 110 is capable of synchronously acquiring membership information and direct payment information.

In some embodiments, when the information capturing device 110 acquires membership information from the payment instrument PC1, the processor 140 may determine that the payment type of the payment instrument PC1 is a membership payment type. When the information capturing device 110 acquires direct payment information from the payment instrument PC1, the processor 140 may determine that the payment type of the payment instrument PC1 is a direct payment type. In some embodiments, the payment instrument PC1 may be, for example, a mobile electronic device or co-branded card, from which the information capturing device 110 may synchronously acquire membership information and direct payment information. When the information capturing device 110 acquires membership information and direct payment information from the payment instrument PC1, the processor 140 may determine that the payment type of the payment instrument PC1 is a hybrid payment type.

From another perspective, after the information capturing device 110 acquires information from the payment instrument PC1, the processor 140 can identify the payment instrument PC1 as a membership card, bank card, stored-value card, or mobile payment device bound with various aforementioned cards, and further determine if the payment type supported by the payment instrument PC1 is a membership payment type, direct payment type, or hybrid payment type. In different embodiments, the processor 140 can identify the payment type of the payment instrument PC1 based on data content, data format, or data transmission protocol provided by the payment instrument PC1.

In Step S320, the processor 140 performs a charging authorization verification of the payment instrument PC1 based on the identified payment type. Since different payment instruments PC1 are corresponding to different payment methods, the processor 140 adopts different authorization request processes to ensure that the charging transactions are correctly performed.

When the payment type of the payment instrument PC1 is identified as a membership payment type, the processor 140 sends a first charging authorization request to the management server CMS1, requesting the management server CMS1 to verify validity or available balance of the member account connected to the payment instrument PC1 based on membership information provided by the payment instrument PC1. The first charging authorization request may include membership information, for example, a membership account number.

When the payment type of the payment instrument PC1 is identified as a direct payment type, the processor 140 sends a pre-authorization request to the financial server FS1 to verify that the payment instrument PC1 of the user has sufficient credit limit or bank account balance to pay the charging fees. If the pre-authorization is successful, the processor 140 sends a second charging authorization request to the management server CMS1. The second charging authorization request may include bank card information, for example, the last digits of the bank card number.

When the payment type of the payment instrument PC1 is identified as a hybrid payment type, the processor 140 sends a pre-authorization request to the financial server FS1 to verify whether the user has sufficient credit limit or bank account balance to pay the charging fees. The processor 140 further sends a first charging authorization request (including membership information) to the management server CMS1 to verify the validity or available balance of the member account or further obtain applicable member discounts.

The management server CMS1 sends the verification results—whether the charging authorization request (the first charging authorization request or the second charging authorization request) is determined successful—to the processor 140. In Step S330, in response to the charging authorization verification being determined successful, the processor 140 initiates a power transfer operation and executes a charging transaction with the payment instrument PC1. In detail, if the payment instrument PC1 is a membership payment type and successfully passes the membership verification by the management server CMS1, the processor 140 receives an authorization success response from the management server CMS1. Alternatively, if the payment instrument PC1 is a direct payment type and the financial server FS1 approves the pre-authorization request with regard to the payment instrument PC1, the processor 140 may receive an authorization success response from the management server CMS1.

In response to receiving the authorization success response, the processor 140 initiates the power transfer operation, outputs power through the charging port, and enables the electric vehicle EV1 to start charging. During the charging process, the processor 140 may calculate charging fees based on the payment type of the payment instrument PC1. After charging is completed, the processor 140 may proceed with payment settlement based on the payment type of the payment instrument PC1. In some embodiments, when the membership information passes the verification by the management server CMS1, the processor 140 calculates the billing amount based on the member discount corresponding to the membership information.

The following will further illustrate the processes of charging authorization verification and charging transactions for membership payment type, direct payment type, and hybrid payment type.

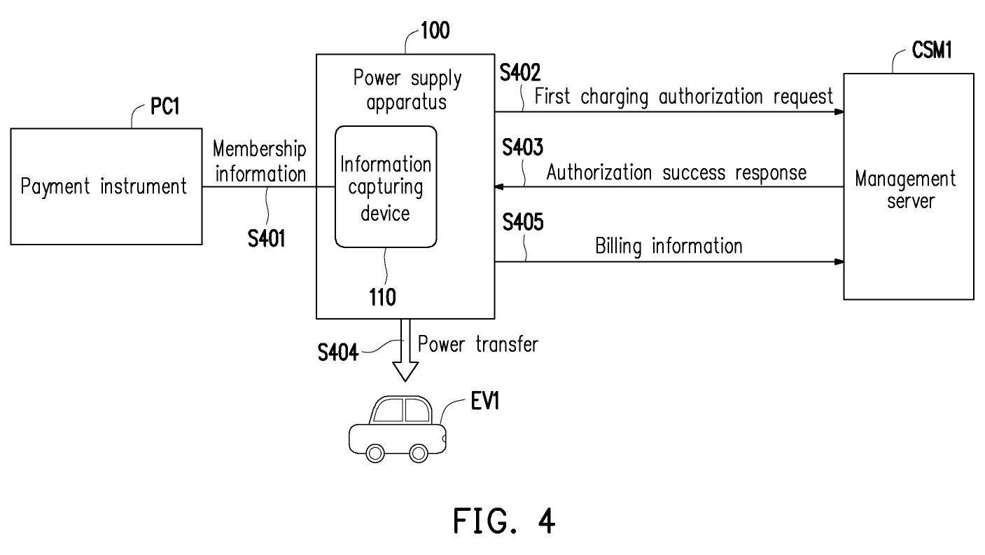

FIG. 4 is a schematic diagram of a payment type being a membership payment type according to an embodiment of the disclosure. Referring to FIG. 4, in Step S401, the information capturing device 110 of the power supply apparatus 100 detects the payment instrument PC1 and acquires membership information from the payment instrument PC1. Thus, the power supply apparatus 100 can identify that the payment instrument PC1 is of a membership payment type. When the payment type of the payment instrument PC1 is a membership payment type, the power supply apparatus 100 may request the management server CMS1 to verify the payment instrument PC1 based on the membership information acquired from the payment instrument PC1. In Step S402, the power supply apparatus 100 may send a first charging authorization request with the membership information to the management server CMS1.

The management server CMS1 may verify the validity of the member account and determine the member discounts based on the membership information in the first charging authorization request. In Step S403, when the management server CMS1 determines that the membership information in the first charging authorization request passes verification, the management server CMS1 may send an authorization success response to the power supply apparatus 100. In Step S404, in response to receiving the authorization success response, the power supply apparatus 100 may initiate the power transfer operation and start delivering power to the electric vehicle EV1. In Step S405, during the charging process or upon charging is completed, the power supply apparatus 100 may transmit billing information such as output power, parking time, billing method to the management server CMS1. Finally, the management server CMS1 may deduct the billed amount from the member account based on the billing information and/or member discount information, and send back a transaction completion confirmation response.

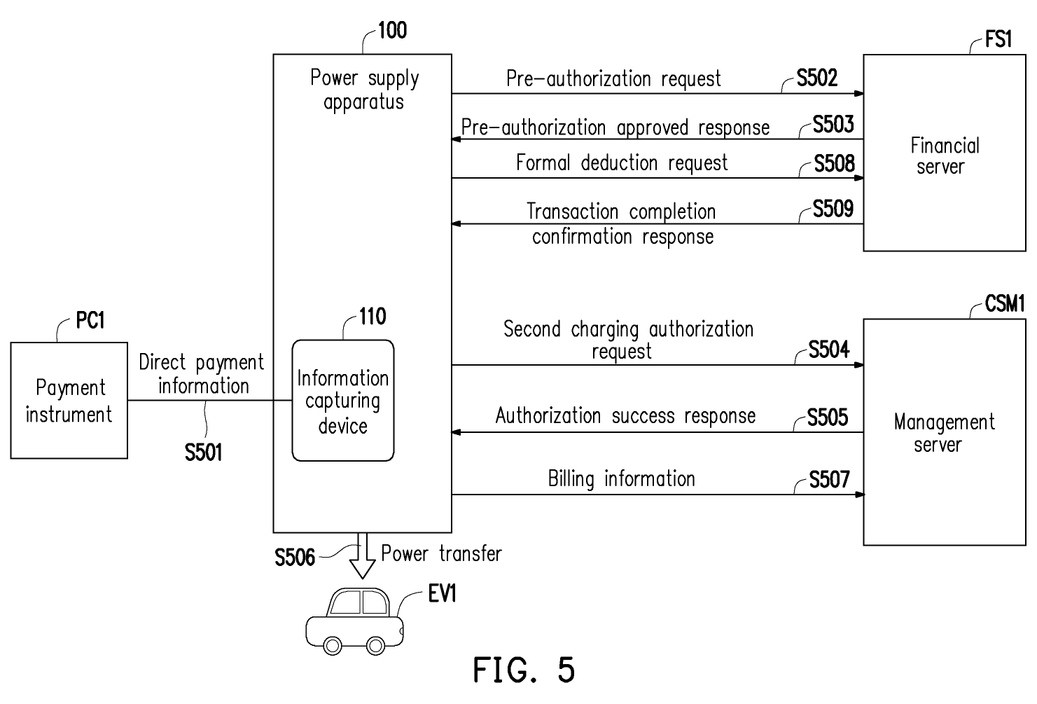

FIG. 5 is a schematic diagram of a payment type being a direct payment type according to an embodiment of the disclosure. Referring to FIG. 5, in Step S501, the information capturing device 110 of the power supply apparatus 100 detects the payment instrument PC1 and acquires direct payment information from the payment instrument PC1. The direct payment information may be bank card information or mobile payment information. Thus, the power supply apparatus 100 can identify that the payment instrument PC1 is of a direct payment type. When the payment type of the payment instrument PC1 is determined as a direct payment type, in Step S502, the power supply apparatus 100 sends a pre-authorization request to the financial server FS1. The pre-authorization request may include a pre-authorized amount.

In Step S503, when the financial server FS1 confirms that the payment instrument PC1 has sufficient balance based on the pre-authorized amount, the financial server FS1 sends a pre-authorization approved response to the power supply apparatus 100. In Step S504, in response to receiving the pre-authorization approved response, the power supply apparatus 100 sends a second charging authorization request to the management server CMS1. The second charging authorization request may include identification information of the payment instrument PC1, such as the last four digits of the bank card. In Step S505, the power supply apparatus 100 may receive an authorization success response from the management server CMS1. In Step S506, in response to receiving the authorization success response, the power supply apparatus 100 may initiate the power transfer operation and start delivering power to the electric vehicle EV1. In Step S507, during the charging process or upon charging is completed, the power supply apparatus 100 may transmit billing information to the management server CMS1.

When charging is completed, the power supply apparatus 100 may calculate the final deduction amount based on the billing information. In Step S508, the power supply apparatus 100 may send a formal deduction request to the financial server FS1, requesting to deduct the final deduction amount from the credit limit or financial account associated with the payment instrument PC1. In Step S509, once the financial server FS1 successfully processes the deduction transaction, the financial server FS1 sends a transaction completion confirmation response back to the power supply apparatus 100, confirming that the transaction has been completed and settled.

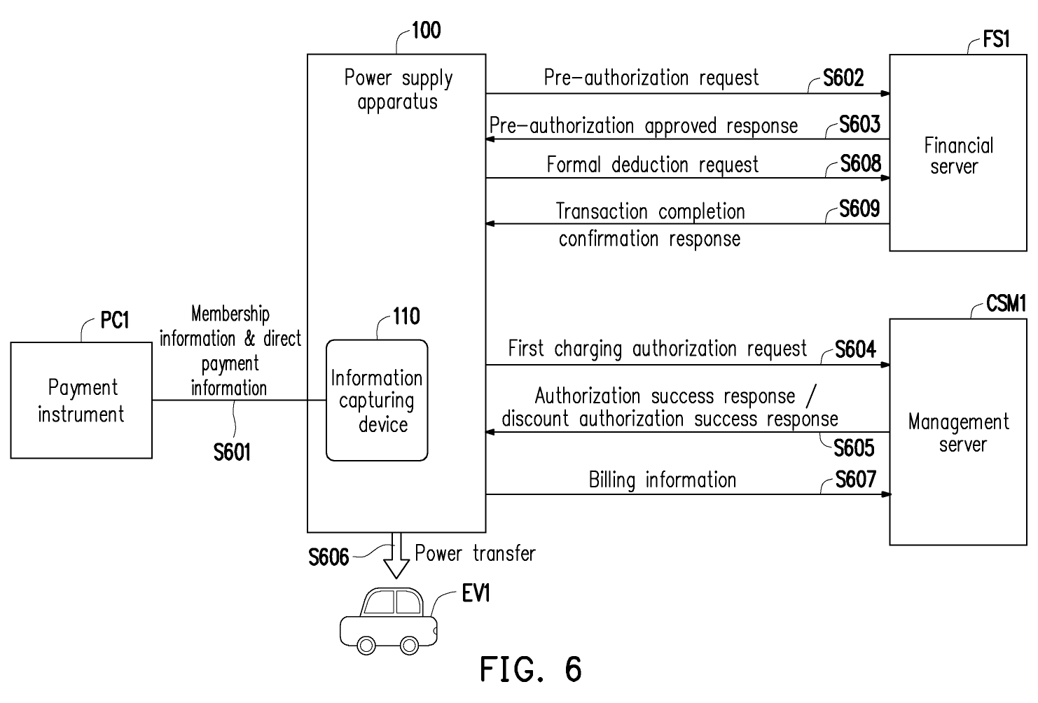

FIG. 6 is a schematic diagram of a payment type being a hybrid payment type according to an embodiment of the disclosure. Referring to FIG. 6, in Step S601, the information capturing device 110 of the power supply apparatus 100 detects the payment instrument PC1 and acquires membership information and direct payment information from the payment instrument PC1. Thus, the power supply apparatus 100 can identify that the payment instrument PC1 is of a hybrid payment type. When the payment type of the payment instrument PC1 is a hybrid payment type, in Step S602, the power supply apparatus 100 sends a pre-authorization request to the financial server FS1. The pre-authorization request may include a pre-authorized amount.

In Step S603, when the financial server FS1 confirms that the payment instrument PC1has sufficient credit limit or account balance based on the pre-authorized amount, the financial server FS1 sends a pre-authorization approved response to the power supply apparatus 100. In Step S604, in response to receiving the pre-authorization approved response, the power supply apparatus 100 sends a first charging authorization request to the management server CMS1. The first charging authorization request may include the membership information of the payment instrument PC1. The management server CMS1 may verify the validity of the member account based on the membership information in the first charging authorization request. In addition, the management server CMS1 may obtain member discounts based on the first charging authorization request.

In Step S605, the power supply apparatus 100 may receive an authorization success response and/or a discount authorization success response from the management server CMS1. The discount authorization success response may include member discounts. Furthermore, when the member account associated with the membership information has applicable member discounts, the management server CMS1 may notify the power supply apparatus 100 of the member discounts. In response to the pre-authorization approved response and/or the authorization success response, in Step S606, the power supply apparatus 100 may initiate the power transfer operation to start delivering electrical power to the electric vehicle EV1. In Step S607, during the charging process or upon charging is completed, the power supply apparatus 100 may transmit billing information to the management server CMS1.

When charging is completed, the power supply apparatus 100 may calculate the final deduction amount based on the billing information and member discount. In Step S608, the power supply apparatus 100 may send a formal deduction request to the financial server FS1 to request deduction of the final amount from the credit limit or financial account associated with the payment instrument PC1. In Step S609, upon successful processing the deduction transaction, the financial server FS1 sends back a transaction completion confirmation response to the power supply apparatus 100, confirming that the transaction has been completed and settled.

In other embodiments, in Step S601, when the payment type of the payment instrument PC1 is identified as the hybrid payment type, Step S604 may be performed first, where the power supply apparatus 100 sends a first charging authorization request to the management server CMS1. The management server CMS1 may verify the validity of the member account, obtain any member discounts based on the membership information in the first charging authorization request, and preferably further confirm a default payment method of the user. If the default payment method of the user is a membership payment type, Steps S602, S603, S608, S609 may be omitted. After receiving the authorization success response and/or discount authorization success response, the power supply apparatus 100 may initiate the power transfer operation. If the default payment method of the user is a direct payment type, the steps indicated in FIG. 5 and FIG. 6 may be referred for execution.

When the power supply apparatus 100 receives a transaction completion confirmation response from the financial server FS1 or the management server CMS1, the processor 140 confirms that the charging transaction has been completed, and may display the payment result to the user via the display 120.

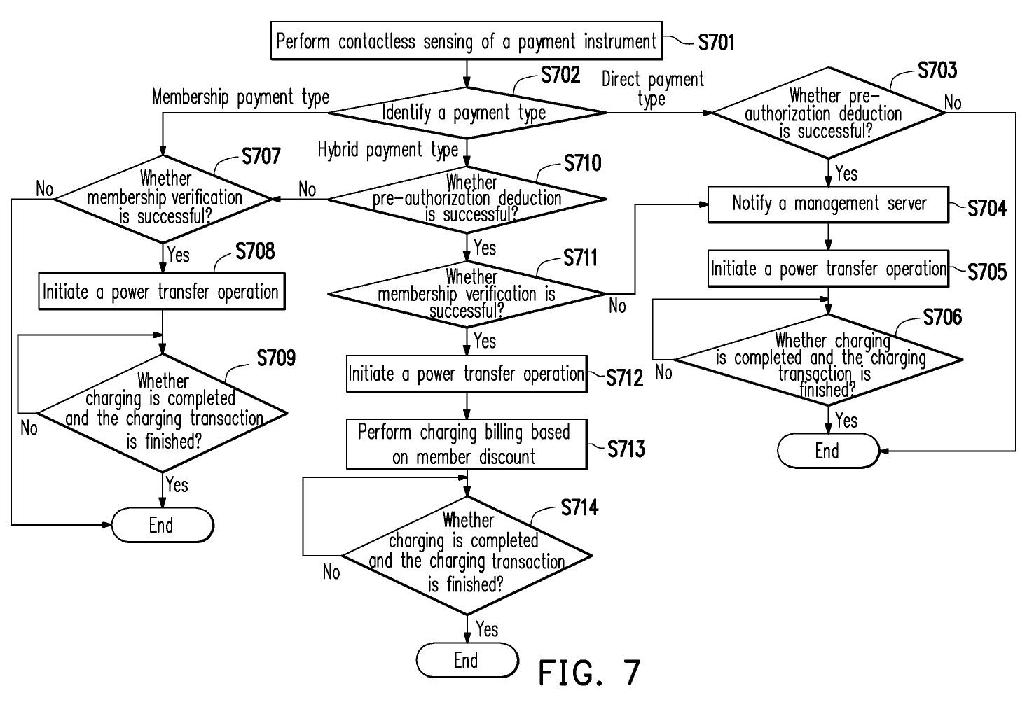

FIG. 7 is a flowchart of a power supply management method according to an embodiment of the disclosure. Referring to FIG. 7, the method flow of this embodiment is applicable to the charging payment system 10 described in the above embodiments. The details of the steps of this embodiment will be described in conjunction with the components of the charging payment system 10.

In Step S701, the power supply apparatus 100 utilizes the wireless sensing module 111 in the information capturing device 110 to perform contactless sensing of the payment instrument PC1. In Step S702, the power supply apparatus 100 identifies the payment type of the payment instrument PC1. When the payment type of the payment instrument PC1 is identified as a direct payment type, in Step S703, the power supply apparatus 100 determines whether the pre-authorization deduction of the financial server FS1 is successful. If Step S703 is determined negative, the power supply apparatus 100 does not initiate the power transfer operation or execute the charging transaction. If Step S703 is determined positive, in Step S704, the power supply apparatus 100 sends a second charging authorization request to notify the management server CMS1. In Step S705, the power supply apparatus 100 initiates the power transfer operation. In Step S706, the power supply apparatus 100 determines whether charging is completed and the charging transaction is finished. Specifically, when the power supply apparatus 100 detects a stop charging command from the user or the management server CMS1, or the charging gun being unplugged from the electric vehicle EV1, the power supply apparatus 100 proceeds with fee settlement and directly charges the fees via the payment instrument PC1.

When the payment type of the payment instrument PC1 is identified as a membership payment type, in Step S707, the power supply apparatus 100 determines whether the membership verification by the management server CMS1 is successful based on the membership information of the payment instrument PC1. If Step S707 is determined negative, the power supply apparatus 100 does not initiate the power transfer operation or execute the charging transaction. If Step S707 is determined positive, in Step S708, the power supply apparatus 100 may initiate the power transfer operation. In Step S709, when the power supply apparatus 100 detects a stop charging command or the charging gun being unplugged from the electric vehicle EV1, the power supply apparatus 100 determines whether charging is completed and the charging transaction is finished. Furthermore, the power supply apparatus 100 may determine that charging is completed and proceed with fee settlement, and directly notify the management server CMS1 to deduct the fees from the member account.

When the payment type of the payment instrument PC1 is a hybrid payment type, in Step S710, the power supply apparatus 100 determines whether the pre-authorization deduction by the financial server FS1 is successful. If Step S710 is determined negative, the power supply apparatus 100 proceeds with Step S707. If Step S710 is determined positive, in Step S711, the power supply apparatus 100 determines whether the membership verification is successful based on the membership information of the payment instrument PC1. If Step S711 is determined negative, the power supply apparatus 100 proceeds with Step S704. That is, when the pre-authorization deduction by the financial server FS1 is successful but membership verification fails, the power supply apparatus 100 may proceed payment deduction via the bank card without relying on the member account.

If Step S711 is determined positive, in Step S712, since the membership verification has been confirmed successful by the management server CMS1 and the power supply apparatus 100, the power supply apparatus 100 may initiate the power transfer operation. In Step S713, the power supply apparatus 100 proceeds with charging billing based on member discount. In Step S714, the power supply apparatus 100 determines whether charging is completed and the charging transaction is finished. Specifically, when the power supply apparatus 100 detects a stop charging command or the charging gun being unplugged from the electric vehicle EV1, the power supply apparatus 100 proceeds with fee settlement and directly charges the fees via the payment instrument PC1.

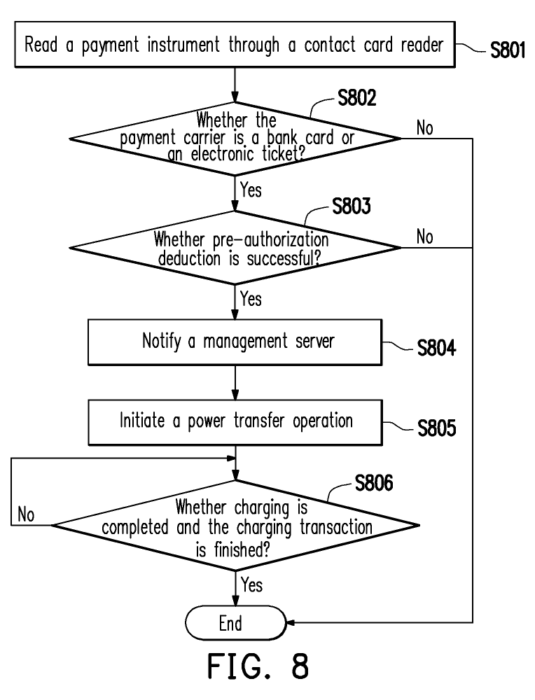

FIG. 8 is a flowchart of a power supply management method according to an embodiment of the disclosure. Referring to FIG. 8, the method flow of this embodiment is applicable to the charging payment system 10 described in the above embodiments. The details of the steps of this embodiment will be described in conjunction with the components of the charging payment system 10.

In Step S801, the power supply apparatus 100 reads the payment instrument PC1 through the contact card reader 112 of the information capturing device 110. In Step S802, the power supply apparatus 100 determines whether the payment instrument PC1 is a bank card or an electronic ticket (for example, a stored-value card, or a membership card). In Step S803, when the payment instrument PC1 is a bank card or an electronic ticket, the power supply apparatus 100 determines whether the pre-authorization deduction by the financial server FS1 is successful. If Step S803 is determined negative, such as when the user mistakenly inserts a card without payment functionality into the card slot of the contact card reader 112, the power supply apparatus 100 will neither initiate the power transfer operation nor execute the charging transaction. If Step S803 is determined positive, in Step S804, the power supply apparatus 100 sends a second charging authorization request to notify the management server CMS1. In Step S805, the power supply apparatus 100 initiates the power transfer operation. In Step S806, the power supply apparatus 100 determines whether charging is completed and the charging transaction is finished. Specifically, when the power supply apparatus 100 detects a stop charging command or the charging gun being unplugged from the electric vehicle EV1, the power supply apparatus 100 proceeds with fee settlement and directly charges the fees through the payment instrument PC1.

In summary, in the embodiments of the disclosure, when the information capturing device of the power supply apparatus detects a payment instrument, the power supply apparatus can automatically identify the payment type of the payment instrument. The power supply apparatus can proceed with authorization verification of the payment instrument based on the identified payment type of the payment instrument, and execute a charging transaction with the payment instrument upon successful authorization verification. The power supply apparatus can automatically distinguish among membership payment type, direct payment type, and hybrid payment type of payment instrument, and dynamically adjust authorization and settlement processes accordingly. Based on above, users do not need to manually select a payment method or change card sensing positions when making payment, thereby making the payment process more intuitive and efficient.

Although the disclosure has been disclosed in terms of the above embodiments, the embodiments are not intended to limit the scope the disclosure. Any person skilled in the art may make minor modifications, combinations, and refinements without departing from the spirit and scope of the disclosure. Therefore, the protection scope of the disclosure shall be determined by the appended claims.

What is claimed is:

1. A power supply apparatus, comprising:
an information capturing device; and
a processor coupled to the information capturing device,
wherein in response to the information capturing device detecting a payment instrument, the processor identifies a payment type of the payment instrument,
the processor performs a charging authorization verification of the payment instrument based on the payment type identified,
in response to the charging authorization verification being determined successful, the processor initiates a power transfer operation and executes a charging transaction with the payment instrument.

2. The power supply apparatus as claimed in claim 1, wherein the information capturing device comprises a wireless sensing module, and the wireless sensing module is configured to contactlessly sense the payment instrument.

3. The power supply apparatus as claimed in claim 1, wherein the information capturing device comprises a contact card reader, and the contact card reader is configured to read the payment instrument.

4. The power supply apparatus as claimed in claim 1, wherein in response to the payment type of the payment instrument being identified as a membership payment type, the processor requests a management server to verify the payment instrument based on membership information provided by the payment instrument.

5. The power supply apparatus as claimed in claim 1, wherein in response to the payment type of the payment instrument being identified as a direct payment type, the processor performs the charging authorization verification to the payment instrument by sending a pre-authorization request to a financial server.

6. The power supply apparatus as claimed in claim 1, wherein in response to the payment type of the payment instrument being identified as a hybrid payment type, the processor sends a pre-authorization request to a financial server, and requests a management server to verify the payment instrument based on membership information of the payment instrument.

7. The power supply apparatus as claimed in claim 1, wherein the payment instrument comprises a mobile electronic device, a bank card, a membership card, or an electronic ticket.

8. The power supply apparatus as claimed in claim 6, wherein in response to the pre-authorization request being approved and the membership information is verified by the management server, the processor proceeds with charging billing based on a member discount corresponding to the membership information.

9. A power supply management method, applicable to a power supply apparatus comprising an information capturing device, wherein the method comprises:
in response to the information capturing device detecting a payment instrument, identifying a payment type of the payment instrument;
performing a charging authorization verification of the payment instrument based on the payment type identified; and
in response to the charging authorization verification being determined successful, initiating a power transfer operation and executing a charging transaction with the payment instrument.

10. The power supply management method as claimed in claim 9, wherein the payment type is a membership payment type, a direct payment type, or a hybrid payment type.

11. The power supply management method as claimed in claim 9, wherein
in response to determining that the payment type of the payment instrument being a membership payment type, requesting a management server to verify the payment instrument based on membership information provided by the payment instrument.

12. The power supply management method as claimed in claim 9, wherein
in response to determining that the payment type of the payment instrument being a direct payment type, sending a pre-authorization request to a financial server to perform the charging authorization verification to the payment instrument.

13. The power supply management method as claimed in claim 9, wherein
in response to determining that the payment type of the payment instrument being a hybrid payment type, sending a pre-authorization request to a financial server, and requesting a management server to verify the payment instrument based on membership information of the payment instrument.

14. The power supply management method as claimed in claim 9, wherein
in response to the information capturing device acquiring membership information and direct payment information from the payment instrument, determining that the payment type is a hybrid payment type.

15. The power supply management method as claimed in claim 13, wherein
in response to the pre-authorization request being approved and the membership information is verified by the management server, proceeding with charging billing based on a member discount corresponding to the membership information.

16. A power supply apparatus, comprising:
a main body;
a charging port connected to the main body, and configured to output electrical power;
an information capturing device disposed on the main body, and configured to collect information of a payment instrument; and
a processor disposed on the main body, and coupled to the charging port and the information capturing device,
wherein the processor is configured to identify the information of the payment instrument and control the charging port to output power based on the information.

17. The power supply apparatus as claimed in claim 16, wherein the information capturing device comprises a sensing area, the sensing area is configured to detect a first payment instrument or a second payment instrument to obtain first information of the first payment instrument or second information of the second payment instrument and send to the processor, and the first payment instrument and the second payment instrument are different.

18. The power supply apparatus as claimed in claim 16, further comprising a display disposed on same surface of the main body as the sensing area of the information capturing device.

19. The power supply apparatus as claimed in claim 16, wherein the information capturing device comprises a contact card reader, and the contact card reader comprises a card slot.

20. The power supply apparatus as claimed in claim 16, further comprising a communication device coupled to the processor.
